(19) United States
(12) Patent Application Publication
(10) Pub. No.: US 2009/0052902 A1
(43) Pub. Date: Feb. 26, 2009

(54) Communication System, Communication Apparatus and Method, and Computer Program

(75) Inventor: Kiichiro Shinokura, Tokyo (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 11/918,346

(22) PCT Filed: Apr. 12, 2006
(86) PCT No.: PCT/JP2006/307719

§ 371 Date: Nov. 23, 2007

(30) Foreign Application Priority Data
Apr. 12, 2005 (JP) 2005-114246

(51) Int. Cl. H04B 10/00

(52) U.S. Cl. 398/118

(57) ABSTRACT

A communication system (1) is provided with: a first communication apparatus (100a); and a second communicating apparatus (100b), the first communicating apparatus is provided with: (i) a displaying device (110) which can perform high-speed modulation; (ii) a display dividing device (112) for dividing a display surface of the displaying device into a plurality of display blocks; and (iii) a controlling device (115) for controlling the displaying device to display a display pattern in each of the divided plurality of display blocks, the second communicating apparatus is provided with: (i) a light receiving device (120) for light-receiving the display pattern which is displayed on the displaying device; and (ii) an obtaining device (121) for obtaining the predetermined data on the basis of the light-received display pattern.

### TECHNICAL FIELD

The present invention relates to a communication system, a communicating apparatus and method, in which a predetermined signal can be transmitted through a space, and a computer program which is used for the communication system or the like.

### BACKGROUND ART

As a method of transmitting a signal through a space, wireless communication is generally known, which uses electric waves or radio waves for communication. For example, as large-scaled wireless communication, television broadcasting, satellite broadcasting, and the like are listed as one example. On the other hand, as relatively small-scaled wireless communication, wireless USB (Universal Serial Bus) communication which uses UWB (Ultra Wide Band), IRDA (Infra Read Data Association) communication, Bluetooth communication, wireless LAN (Local Area Network) communication are listed as one example.

On the other hand, a method of transmitting a signal through a space without using the electric waves for communication has been developed. As a representative example, there is a communication method which uses visible light. For example, there has been developed a method in which a plurality of LED (Light Emitting Diodes) are arranged, and light is emitted in accordance with data which is transmitted from each of the LED, as occasion demands, to thereby transmit a signal. Alternatively, there has been developed a method (e.g. a display-use VLC (Visible Light Communication)) of transmitting a signal by using color brink (or a hue blink signal) on a normal liquid crystal display or the like.

### DISCLOSURE OF INVENTION

### Subject To Be Solved By the Invention

However, in the wireless communication using the electric waves for communication, exclusive parts for transmitting a signal are necessary, and a space for disposing the parts is also necessary. Such a cost demerit or a demerit related to an increase in apparatus size can be a barrier particularly for the popularization of the communication system for general users. Moreover, in the wireless communication using the electric waves for communication, a transmission rate is relatively low, and only the wireless USB using the UWB can realize a transmission rate of 480 Mbps (Mega bit per second). However, in order to transmit a signal, such as video images and music, the transmission rate of 480 Mbps is not completely sufficient.

On the other hand, even in the communication method using visible light, exclusive parts, such as the LED, are necessary, and this method likely has the same problems as those of the wireless communication using the electric waves for communication. Moreover, even in the display-use VLC, the transmission rate is extremely low, and a signal, such as video images and music, is hardly transmitted or cannot be transmitted.

The aforementioned problems are listed as one example of the subject to be solved in the present invention. It is therefore an object of the present invention to provide a communication system, a communicating apparatus and method, which enable a signal to be preferably transmitted through a space, and a computer program which makes a computer as the communication system.

### Means For Solving the Subject

### Communication System

The above object of the present invention can be achieved by a communication system provided with: a first communication apparatus; and a second communicating apparatus, the first communicating apparatus provided with: (i) a displaying device which can perform high-speed modulation; (ii) a display dividing device for dividing a display surface of the displaying device into a plurality of display blocks; and (iii) a controlling device for controlling the displaying device to display a display pattern, which indicates corresponding predetermined data, in each of the divided plurality of display blocks, the second communicating apparatus provided with: (i) a light receiving device for light-receiving the display pattern which is displayed on the displaying device; and (ii) an obtaining device for obtaining the predetermined data on the basis of the light-received display pattern.

According to the communication system of the present invention, the predetermined data can be transmitted from the first communicating apparatus to the second communicating apparatus. Specifically, the data can be transmitted by displaying the display pattern, which indicates the data, on the displaying device provided for the first communicating apparatus, and by light-receiving the display pattern (more specifically, light emitted from the first communicating apparatus by the display of the display pattern) on the light receiving device provided for the second communicating apparatus.

The displaying device is adapted to perform high-speed modulation. The expression “ . . . can perform high-speed modulation” indicates that each of a plurality of pixel portions or emission portions, which constitute the displaying device, can blink in a relatively short cycle. For example, the displaying device is adapted to perform modulation at a modulation rate of 10 Mbps. In this case, each of the plurality of pixel portions or emission portions can blink 10 million times per second. The displaying device preferably can perform modulation at a modulation rate which is greater than at least a modulation rate of an existing liquid crystal display or the like. The display surface of the displaying device is divided into the plurality of display blocks by the operation of the display dividing device. Then, by the operation of the controlling device, the displaying device is controlled to display the display patterns, each of which respectively corresponds to each of the divided plurality of display blocks. More specifically, one display pattern corresponding to one data is displayed in one display block, and another display pattern corresponding to another data is displayed in another display block. Alternatively, one display pattern corresponding to one portion of one data is displayed in one display device, and another display pattern corresponding to another portion of one data is displayed in another display device. Then, for example, if the display block is in a “bright state”, the display block may indicate “1”, and if the display block is in a “dark state”, the display block may indicate “0”. Alternatively, the data may be indicated, more variously, in accordance with the color or the like of the display pattern.

By displaying the display pattern on the displaying device, the light corresponding to the display pattern is propagated from the first communicating apparatus to the second communicating apparatus. On the second communicating apparatus, the light corresponding to the display pattern is received by the operation of the light receiving device. After that, by virtue of the operation of the obtaining device, the data transmitted from the first communicating apparatus is obtained on the basis of the light-received display pattern.

As explained above, according to the communication system of the present invention, it is possible to preferably transmit the data from the first communicating apparatus to the second communicating apparatus by propagating the light corresponding to the display pattern through a space. In particular, since the display pattern is displayed by the operation of the displaying device which can perform high-speed modulation, it is possible to increase the amount of data which can be transmitted per unit time. Moreover, it is possible to display the different display patterns in the plurality of divided display blocks. That is, data parallel transmission (or parallel communication) can be performed, so that it is possible to increase the amount of data which can be transmitted per unit time. For example, if the display surface of the displaying device which can perform modulation at a modulation rate of 10 Mbps is divided into 100 display blocks, it is possible to transmit the data with at most 10 Mbps×100=1 Gb (Giga bit) per second. As described above, according to the communication system in the present invention, it is possible to preferably transmit a large volume of data through a space. As a result, it is also possible to preferably transmit various contents including video images, audio, or the like.

In addition, for example, general display equipment (e.g. a display or the like) can be used as the first communicating apparatus, and general imaging equipment (e.g. a camera or the like) can be used as the second communicating apparatus. Thus, in order to realize the communication system in the present invention, it is not necessary to use relatively expensive or relatively massive exclusive parts. This allows the reduced cost as the entire communication system, to thereby realize the communication system which can be easily handled by a user, relatively easily.

Moreover, the data can be transmitted as long as the display pattern is displayed on the first communicating apparatus and the displayed display pattern is light-received on the second communicating apparatus. Therefore, it is not necessary for the first communicating apparatus to display the display pattern with aiming the second communicating apparatus. It is also unnecessary to select the second communicating apparatus, which is to light-receive the display pattern, in advance on the first communicating apparatus side. In other words, this allows a simple preparation process for the data transmission. In addition, it is possible to realize the high-response data transmission.

In one aspect of the communication system of the present invention, the displaying device includes an organic EL (Electro Luminescence) display.

According to this aspect, the organic EL display, which is a display which can perform high-speed modulation, is used to realize the communication system in the present invention, relatively easily. As a result, it is possible to receive the aforementioned various benefits.

In another aspect of the communication system of the present invention, the dividing device divides the display surface into a plurality of strip blocks which extend in one direction, as the plurality of display blocks.

According to this aspect, the display surface is divided along with a longitudinal direction or a lateral direction (or X-axis direction or Y-axis direction). As a result, the display surface is divided into the plurality of strip-shaped display blocks, each of which extends in the longitudinal direction or the lateral direction (or the X-axis direction or the Y-axis direction). Therefore, the display surface of the displaying device can be divided, relatively easily. Moreover, it is also possible to display the corresponding display pattern in each of the display blocks, relatively easily. This is a great advantage, particularly in the case of the displaying device in which pixels are arranged in a matrix, like an organic EL display.

In another aspect of the communication system of the present invention, the dividing device divides the display surface into a plurality of strip blocks which extend in one direction and which are further divided into another direction which is different from the one direction, as the plurality of display blocks.

According to this aspect, the display surface is divided along with each of the longitudinal direction and the lateral direction (or the X-axis direction and the Y-axis direction). As a result, the display surface is divided into the plurality of strip-shaped display blocks, which extend in the longitudinal direction or the lateral direction (or X-axis direction or Y-axis direction). Therefore, the display surface of the displaying device can be divided, relatively easily. Moreover, it is also possible to display the corresponding display pattern in each of the display blocks, relatively easily. This is a great advantage, particularly in the case of the displaying device in which pixels are arranged in a matrix, like an organic EL display.

In another aspect of the communication system of the present invention, the dividing device divides the display surface into the plurality of display blocks which are distributed in a matrix.

According to this aspect, it is possible to divide the display surface of the displaying device in which pixels are normally distributed in a matrix, relatively easily. Moreover, it is also possible to display the corresponding display pattern in each of the display blocks, relatively easily.

In another aspect of the communication system of the present invention, the display pattern includes a pilot pattern which indicates a reference position of the display pattern, and the second communicating apparatus is further provided with a correcting device for correcting at least one of a distortion of the light-received display pattern, an angle of the light-received display pattern, a position of the light-received display pattern, and a focus of the light receiving device when the display pattern is light-received, on the basis of the pilot pattern.

According to this aspect, it is possible to preferably correct the optical distortion or the like of the display pattern by using the pilot pattern. By this, it is possible to preferably light-receive the display pattern. As a result, it is possible to preferably obtain the original data from the light-received display pattern.

In an aspect of the communication system provided with the correcting device, as described above, the second communicating apparatus may be further provided with a light receiving dividing device for dividing a light receiving surface of the light receiving device into a plurality of light receiving blocks corresponding to the respective plurality of display blocks, on the basis of a correction result of the correcting device.

By virtue of such construction, by the operation of the light receiving device, the light receiving surface of the light receiving device is divided into the plurality of light receiving blocks so as to correspond to the respective plurality of display blocks, on the basis of the correction result of the correcting device. In other words, the light receiving surface of the light receiving device is divided into the plurality of light receiving blocks in order to light-receive the display pattern, which is displayed in each of the plurality of display blocks, without omission and correctly. For example, the light receiving surface is divided into one light receiving block for light-receiving the display pattern which is displayed in one display block, and another light receiving block for light-receiving the display pattern which is displayed in another display block. By this, it is possible to preferably light-receive the display pattern, which is displayed in each of the plurality of display blocks. As a result it is possible to preferably obtain the original data from the light-received display pattern.

In an aspect of the communication system provided with the correcting device, as described above, the controlling device may control the displaying device to display the pilot pattern before the display of the display pattern.

By virtue of such construction, the pilot pattern is displayed on the displaying device before the display of the display pattern which indicates the actual data. Therefore, on the second communicating apparatus, it is possible to perform the aforementioned correction before the light-reception of the display pattern, by using the pilot pattern, which is displayed in advance. Moreover, the display of the pilot pattern can be used as a sign to start the transmission.

In another aspect of the communication system of the present invention, the light receiving device is provided with a photo detector element including a condenser which can be separated from a circuit system.

According to this aspect, it is possible to preferably light-receive the display pattern without accumulating electric charges on the condenser, by separating the condenser from the circuit system. That is, it is possible to ensure the high-speed responsiveness of the light receiving device, and it is also possible to preferably light-receive even the display pattern that is displayed on the displaying device which can perform high-speed modulation.

On the other hand, if the condenser is not separated from the circuit system, it can function as a normal CMOS image sensor or a CCD image sensor. For example, it can also function as a camera and a video camera.

In another aspect of the communication system of the present invention, a space block in which the display pattern is not displayed is inserted between each adjacent two of the plurality of display blocks.

According to this aspect, it is possible to preferably prevent such a disadvantage that the light leaks from the adjacent display block. Therefore, it is possible to reduce an influence of crosstalk caused by the light of the adjacent display block, to thereby improve transmission quality.

In another aspect of the communication system of the present invention, at least one of the plurality of display blocks has a circular shape.

According to this aspect, it is possible to reduce an influence of crosstalk caused by the defocus on the light receiving device, to thereby improve transmission quality.

In another aspect of the communication system of the present invention, the first communicating apparatus is further provided with the light receiving device and the obtaining device, and the second communicating apparatus is further provided with the displaying device and the controlling device.

According to this aspect, the first communicating apparatus has the structure of the second communicating apparatus, and the second communicating apparatus has the structure of the first communicating apparatus. Therefore, the data can be transmitted not only from the first communicating apparatus to the second communicating apparatus, but also from the second communicating apparatus to the first communicating apparatus. That is, two-way transmission (or two-way communication) can be performed between the first communicating apparatus and the second communicating apparatus.

### Communicating Apparatus

The above object of the present invention can be also achieved by communicating apparatus provided with: a displaying device which can perform high-speed modulation; a display dividing device for dividing a display surface of the displaying device into a plurality of display blocks; a controlling device for controlling the displaying device to display a display pattern, which indicates corresponding predetermined data, in each of the divided plurality of display blocks; a light receiving device for light-receiving the display pattern which is displayed on the displaying device; and an obtaining device for obtaining the predetermined data on the basis of the light-received display pattern.

According to the communicating apparatus of the present invention, it has each of the functions of the first communicating apparatus and the second communicating apparatus, which are provided for the aforementioned communication system of the present invention. Therefore, two-way communication can be performed by using the communicating apparatus. As a result, it is possible to receive the same various benefits as those of the aforementioned communication system of the present invention.

Incidentally, in response to the various aspects of the communication system of the present invention described above, the communicating apparatus of the present invention can employ various aspects.

### Communicating Method

The above object of the present invention can be also achieved by a communicating method in a communication system provided with: a first communication apparatus; and a second communicating apparatus, the first communicating apparatus provided with a displaying device which can perform high-speed modulation, the second communicating apparatus provided with a light receiving device for light-receiving the display pattern which is displayed on the displaying device, the communicating method provided with: a display dividing process of dividing a display surface of the displaying device into a plurality of display blocks; a controlling process of controlling the displaying device to display a display pattern, which indicates corresponding predetermined data, in each of the divided plurality of display blocks; and an obtaining process of obtaining the predetermined data on the basis of the light-received display pattern.

According to the communicating method of the present invention, it is possible to receive the same various benefits as those of the aforementioned communication system of the present invention.

Incidentally, in response to the various aspects of the communication system of the present invention described above, the communicating method of the present invention can employ various aspects.

### Computer Program

The above object of the present invention can be also achieved by a computer program for a communication control to control a computer provided in the aforementioned communication system of the present invention (including its various aspects), the computer program making a computer function as at least one portion of the first communicating apparatus and the second communicating apparatus.

According to the computer program of the present invention, the aforementioned communication system of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects in the aforementioned communication system of the present invention, the computer program of the present invention can adopt various aspects.

The above object of the present invention can be also achieved by a computer program product in a computer-readable medium for tangibly embodying a program of instructions executable by a computer provided in the aforementioned communication system of the present invention (including its various aspects), the computer program product making a computer function as at least one portion of the first communicating apparatus and the second communicating apparatus.

According to the computer program product of the present invention, the aforementioned communication system of the present invention can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned communication system of the present invention.

These effects and other advantages of the present invention will become more apparent from the following embodiments.

As explained above, according to the communication system of the present invention, it is provided with the first communicating apparatus and the second communicating apparatus, the first communicating apparatus provided with the displaying device, the display dividing device, and the controlling device, the second communicating apparatus provided with the light receiving device and the obtaining device. According to the communicating method of the present invention, it is provided with the display dividing process, the controlling process, and the obtaining process. Moreover, according to the communicating apparatus of the present invention, it is provided with the displaying device, the display dividing device, the controlling device, the light receiving device and the obtaining device. Therefore, it is possible to transmit a signal through a space, preferably.

### BRIEF DESCRIPTION OF DRAWINGS

FIG. 1 is a schematic diagram conceptually showing the basic structure of a communication system in an embodiment.

FIG. 2 is a block diagram conceptually showing the basic structure of a terminal which is used for the communication system in the embodiment.

FIG. 3 is a flowchart conceptually showing a flow of the operation of the communication system in the embodiment.

FIG. 4 are plan views conceptually showing specific examples of a pilot pattern.

FIG. 5 is a perspective view conceptually showing an optical path when a display pattern, which is displayed on a display device, is received on a light receiving device.

FIG. 6 is a plan view conceptually showing one aspect of the division of a display surface and one aspect of the pilot pattern.

FIG. 7 is a plan view conceptually showing another aspect of the division of the display surface and another aspect of the pilot pattern.

FIG. 8 is a plan view conceptually showing another aspect of the division of the display surface and another aspect of the pilot pattern.

FIG. 9 is a circuit diagram conceptually showing the circuit structure of a PD which constitutes the light receiving device.

FIG. 10 is a plan view conceptually showing another aspect of the division of the display surface and another aspect of the pilot pattern.

FIG. 11 is a plan view conceptually showing another aspect of the division of the display surface and another aspect of the pilot pattern.

### DESCRIPTION OF REFERENCE CODES

1 communication system
100a, 100b terminal
110 display device
110a to 110j display block
110s space block
112 display surface division circuit
113 display pattern generation circuit
114 pilot pattern generation circuit
115 display control device
120 light receiving device
122 light receiving signal processing circuit
123 correction circuit/corresponding PD specification circuit

### BEST MODE FOR CARRYING OUT THE INVENTION

Hereinafter, the best mode for carrying out the present invention will be explained in each embodiment in order with reference to the drawings.

### (1) Basic Structure

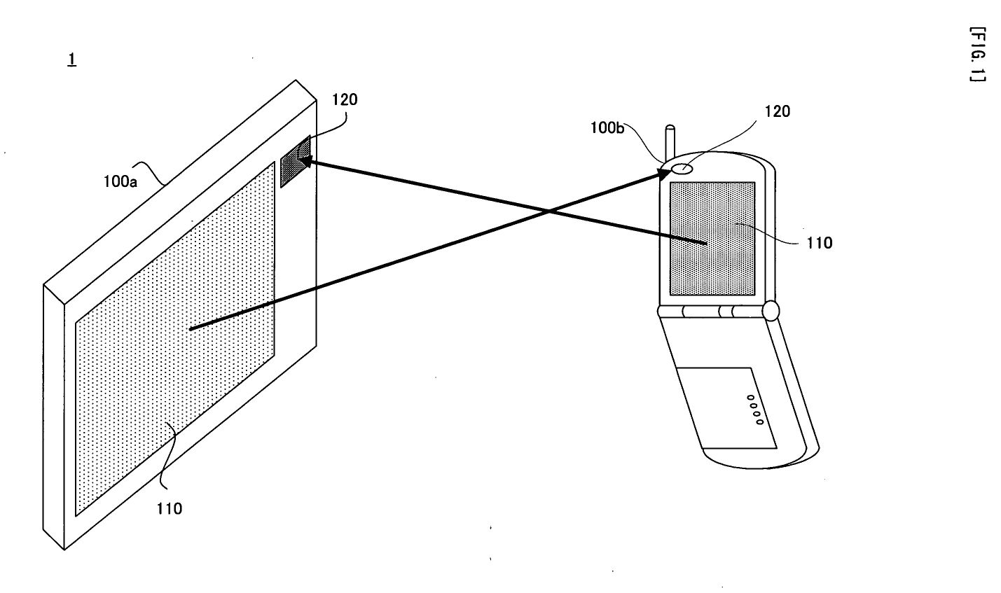

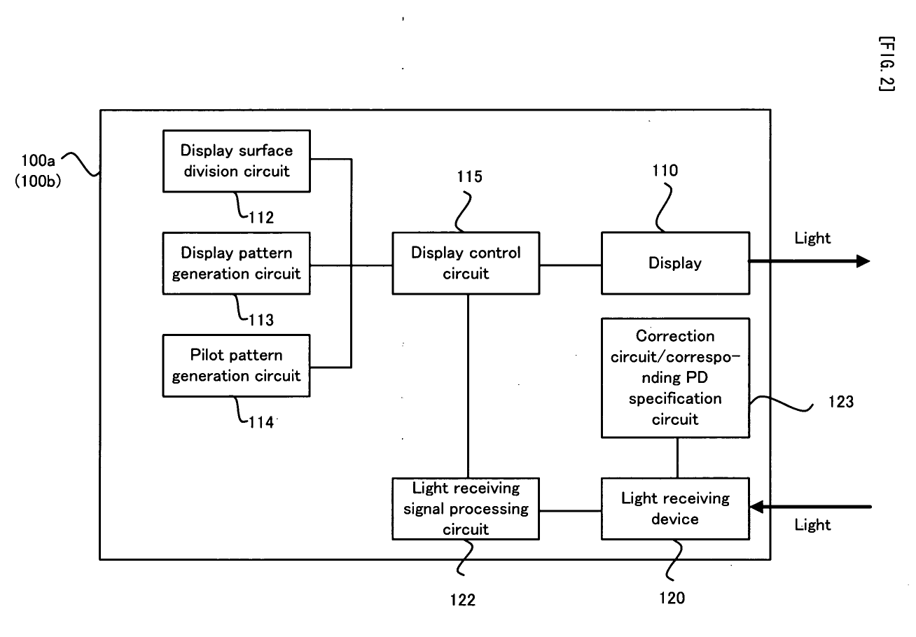

Firstly, with reference to FIG. 1 and FIG. 2, the basic structure of an embodiment of the communication system of the present invention will be explained. FIG. 1 is a schematic diagram conceptually showing the basic structure of a communication system 1 in the embodiment. FIG. 2 is a block diagram conceptually showing the basic structure of a terminal which is used for the communication system 1 in the embodiment.

As shown in FIG. 1, the communication system 1 is provided with a terminal 100a and a terminal 100b, each of which constitutes one specific example of the “communicating apparatus” of the present invention. Each of the terminal 100a and the terminal 100b is provided with: a display device 110, which constitutes one specific example of the “displaying device” of the present invention; and a light receiving device 120, which constitutes one specific example of the “light receiving device” of the present invention. A display pattern which is displayed on the display device 110 of the terminal 100a is light-received (or imaged) on the light receiving device 120 of the terminal 100b, and a display pattern which is displayed on the display device 110 of the terminal 100b is light-received (or imaged) on the light receiving device 120 of the terminal 100a. The display pattern displayed on the display device 110 is generated by modulating e.g. predetermined data. By demodulating or the like the display pattern, the data transmission from the terminal 100a to the terminal 100b, or from the terminal 100b to the terminal 100a can be realized. In other words, the data transmission which uses visible light (e.g. VLC (Visible Light Communication)) is performed between the terminal 100a and the terminal 100b.

As shown in FIG. 2, the terminal 100a and the terminal 100b have the same structure, and each of the terminals is provide with: the display device 110; a display surface division circuit 112, which constitutes one specific example of the “display dividing device” of the present invention; a display pattern generation circuit 113; a pilot pattern generation circuit 114; a display control circuit 115, which constitutes one specific example of the “controlling device” of the present invention; the light receiving device 120; a light receiving signal processing circuit 122, which constitutes one specific example of the “obtaining device” of the present invention; and a correction circuit/corresponding PD (Photo Detector) specification circuit, which constitutes one specific example of the “correcting device” and the “light receiving dividing device” of the present invention.

The display device 110 includes a display which can perform high-speed modulation. More specifically, the display device 110 includes an organic EL display which can perform modulation, for example, at a modulation rate of several kbps or several tens Mbps. Of course, any display that can perform modulation at a predetermined modulation rate can transmit the data between the terminal 100a and the terminal 100b.

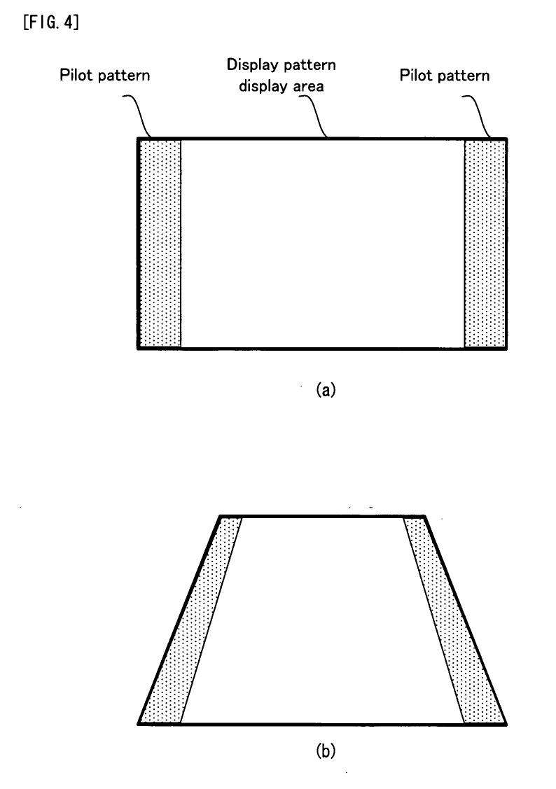

The display surface division circuit 112 is adapted to divide the display surface of the display device 110 into a plurality of display blocks. The dividing aspect of the display surface will be detailed later (refer to FIG. 4 or the like).

The display pattern generation circuit 113 is adapted to generate a display pattern which is displayed on the display device 110 whose display surface is divided into the plurality of display blocks. More specifically, the display pattern generation circuit 113 is adapted to generate one or a plurality of display patterns to be displayed on each of the plurality of display blocks, in association with each of the plurality of display blocks.

The display pattern is generated on the basis of the data to be transmitted from the terminal 100a to the terminal 100b, or from the terminal 100b to the terminal 100a. For example, the display pattern is generated by modulating the data to be transmitted from the terminal 100a to the terminal 100b or from the terminal 100b to the terminal 100a. In other words, the display pattern generation circuit 113 is adapted to convert the data to be transmitted (e.g. digital data which consists of “0” and “1”, or analog data), to the display pattern displayed on the corresponding display block. Then, the display pattern may be constructed by using a display modulation aspect, such as its blink, brightness, color, and arrangement. Specifically, a pattern which blinks in accordance with the data to be transmitted may be regarded as the display pattern. For example, a pattern with predetermined brightness corresponding to the data to be transmitted, or a pattern which changes its brightness in accordance with the data to be transmitted, may be regarded as the display pattern. For example, a pattern in a predetermined color corresponding to the data to be transmitted, or a pattern which changes its color in accordance with the data to be transmitted, may be regarded as the display pattern. Alternatively, a pattern which changes its position in accordance with the data to be transmitted may be regarded as the display pattern. Alternatively, the display pattern may be constructed by combining these display aspects or by using other display aspects.

The pilot pattern generation circuit 114 is adapted to generate a pilot pattern, which indicates a range of the display pattern displayed for transmitting the data (in other words, which indicates the position of the display pattern displayed for transmitting the data). The pilot pattern will be detailed later (refer to FIG. 4 or the like).

The display control circuit 115 is adapted to control the display driving of the display device 110. Specifically, the display control circuit 115 controls the display driving of the display device 110 so as to display each of the display pattern, generated by the display pattern generation circuit 113, and the pilot pattern, generated by the pilot pattern generation circuit 114, on the display device 110. Moreover, the display control circuit 115 can be adapted to control the display driving of the display device 110 so as to display the normal image or the like.

The light receiving device 120 includes e.g. a plurality of PDs (Photo Detectors), and it is adapted to light-receive the display pattern and the pilot pattern displayed on the facing display device 110 (more specifically, the light emitted from the display device 110 due to the display of the display pattern and the pilot pattern).

The light receiving signal processing circuit 122 is adapted to demodulate a light receiving signal, which is received on the light receiving circuit 120, and to obtain the transmitted data. If the transmitted data includes a video signal, for example, the video signal is outputted to the display control circuit 115. By this, video images can be displayed on the display device 110 on the basis of the transmitted data.

The correction circuit/corresponding PD specification circuit 123 is adapted to correct an optical distortion of the display pattern, which is light-received on the light receiving device 120, on the basis of the pilot pattern, which is light-received on the light receiving device 120. More specifically, it performs the correction of tilt, rotation, or the like, with respect to the image of the display pattern, which is light-received on the light receiving device 120. Moreover, it is also adapted to adjust the focus of the light receiving device 120. Moreover, it is also adapted to specify the PD (or PD group) that is to light-receive the display pattern displayed in each of the plurality of display blocks, from the plurality of PDs included in the light receiving device 120. That is, it is adapted to specify the PD (or PD group) corresponding to each of the plurality of display blocks, respectively.

As the terminal 100a and the terminal 100b, for example, an organic EL display with a camera, a mobile phone with a camera, a video camera with a display, a camera with a display, and the like are listed as one specific example. Of course, even another specific example, if it is provided with the display device 110 and the light receiving device 120, it obviously corresponds to one specific example of the terminal 100a and the terminal 100b.

Incidentally, in the aforementioned communication system 1, each of the terminal 100a and the terminal 100b is provided with the display device 110 and the light receiving device 120. However, even if the terminal 100a is not provided with the light receiving device 120 and if the terminal 100b is not provided with the display device 110, the data can be transmitted from the terminal 100a to the terminal 100b, and such a structure is obviously included in the communication system of the present invention.

### (2) Operation Principle

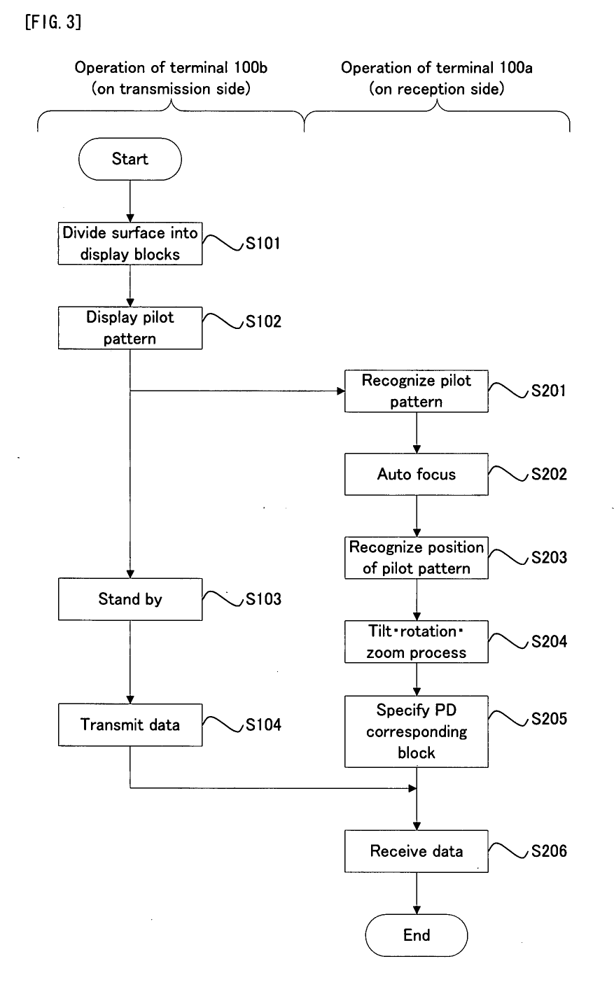

Next, with reference to FIG. 3 to FIG. 8, the operation of the communication system 1 in the embodiment will be explained. Here, by using FIG. 3, the entire flow of the operation of the communication system 1 in the embodiment will be explained. Then, with reference to FIG. 4 to FIG. 8, as occasion demands, a more specific or more detailed explanation will be given. FIG. 3 is a flowchart conceptually showing a flow of the operation of the communication system 1 in the embodiment.

Incidentally, here, an explanation will be given under the assumption that the terminal 100a is on the reception side (or the terminal that receives the data) and that the terminal 100b is on the transmission side (or the terminal that transmits the data).

As shown in FIG. 3, firstly, by virtue of the operation of the display surface division circuit 112 of the terminal 100b, the display surface of the display device 110 of the terminal 100b is divided into a plurality of display blocks (step S101). After that, the pilot pattern, generated by the operation of the pilot pattern generation circuit 114 of the terminal 100b, is displayed on the display surface of the display device 110 of the terminal 100b (step S102). At this time, the terminal 100b is preferably located such that the light emitted from the display device 110 of the terminal 100b preferably enters the light receiving device 120 of the terminal 100a. The pilot pattern is displayed to inform the terminal 100a that the data is about to be transmitted from the terminal 100b. In addition, the pilot pattern is displayed for adjustment of the light receiving device 120 in order to preferably light-receive the display pattern, which is displayed on the display device 110 of the terminal 100b.

After displaying the pilot pattern, the terminal 100b stands by for a predetermined time (step S103). This allows that the terminal 100a recognizes the pilot pattern and prepares for the reception of the data to be transmitted. At this time, the terminal 100b preferably stands by for the time that is necessary and sufficient to prepare for the reception of the data to be transmitted. After the stand-by for the predetermined time, the display pattern corresponding to the data to be transmitted is displayed on the display device 110 of the terminal 100b (step S104).

On the other hand, on the terminal 100a, firstly, the pilot pattern, which is displayed in the step S102, is recognized by the light receiving device 120 of the terminal 100a (step S201). After that, the light receiving device 120 of the terminal 100a performs focusing, on the basis of the recognized pilot pattern (step S202). More specifically, the light receiving device 120 of the terminal 100a focuses on the display device 110 of the terminal 100b (in particular, a portion in which the display pattern is displayed). After that, in addition to the recognition of the pilot pattern itself, the position or the like of the pilot pattern (e.g. the position, shape, or the like of the pilot pattern on a light receiving surface of the light receiving device 120) is recognized (step S203). Then, by virtue of the operation of the correction circuit/corresponding PD specification circuit 123, the correction of tilt, the correction of rotation, the correction of zoom, or the like is performed on the image of the display pattern which is light-received on the light receiving device 120, in accordance with the position or the like of the recognized pilot pattern (step S204). Moreover, the PD (or PD group) corresponding to each of the plurality of display blocks is specified in accordance with the position or the like of the recognized pilot pattern (step S205).

After that, the display pattern, which is displayed in the step S104, is light-received on the light receiving device 120 of the terminal 100a, and the light-received display pattern is demodulated to obtain the original data by the operation of the light receiving signal processing circuit 122 of the terminal 100a (step S206). In this manner, the data is transmitted from the terminal 100b to the terminal 100a.

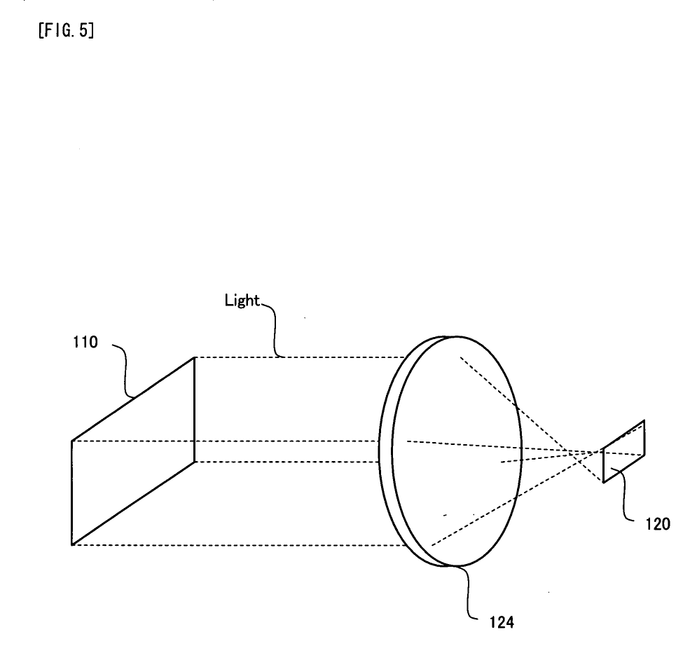

Now, with reference to FIG. 4 and FIG. 5, the specific examples of the pilot pattern will be explained. FIG. 4 are plan views conceptually showing specific examples of the pilot pattern. FIG. 5 is a perspective view conceptually showing an optical path when the display pattern, which is displayed on the display device 110, is received on the light receiving device 120.

As shown in FIG. 4(a), the pilot patterns are disposed on the both ends of an area in which the display pattern is displayed. In other words, the display pattern, which indicates the data, is displayed in an area whose edges are surrounded by the pilot patterns. Therefore, the terminal 100a recognizes the display pattern in the area surrounded by the pilot patterns for each of the divided display blocks, and it demodulates the recognized display pattern to the original data.

Here, as shown in FIG. 5, the display pattern and the pilot pattern, which are displayed on the display device 110 (or one portion thereof) of the terminal 100b, are light-received by the light receiving device 120 through an imaging lens 124, which is on an optical path between the display device 110 of the terminal 100b and the light receiving device 120 of the terminal 100a and which is disposed in the terminal 100a. At this time, the display pattern and the like are reversed when they passes through the imaging lens, and then light-received by the light receiving device 120. Therefore, if the display device 110 of the terminal 100b and the light receiving device 120 of the terminal 100a face to each other, the pilot pattern, which is displayed on the display device 110 of the terminal 100b in the shape shown in FIG. 4(a), is recognized as it is, by the light receiving device 120 of the terminal 100a.

However, if the display device 110 of the terminal 100b and the light receiving device 120 of the terminal 100a do not face to each other, the pilot pattern, which is displayed on the display device 110 of the terminal 100b in the shape shown in FIG. 4(a), is recognized, for example, in a distorted shape, as shown in FIG. 4(b), by the light receiving device 120 of the terminal 100a. In this case, if the distortion is not corrected, the display pattern is also light-received in a distorted shape in the same manner, by the light receiving device 120 of the terminal 100a. As a result, it is hardly or cannot be demodulated to the original data. Therefore, in the embodiment, as described above, the distortion is corrected by comparing the shape of the pilot pattern, which is actually light-received on the light receiving device 120, with the shape of the original pilot pattern. Moreover, the PD (or PD group) corresponding to each of the plurality of display blocks is specified.

Incidentally, the pilot pattern may be constructed in the simple pattern shape, as shown in FIG. 4(a). Alternatively, the pilot pattern may be constructed by using a display modulation aspect, such as the pattern's blink, brightness, color, and arrangement. Specifically, a pattern which blinks in accordance with a predetermined rule may be regarded as the display pattern. For example, a pattern with predetermined brightness or a pattern which changes its brightness in accordance with a predetermined rule may be regarded as the display pattern. For example, a pattern in a predetermined color or a pattern which changes its color in accordance with a predetermined rule may be regarded as the display pattern. Alternatively, a pattern disposed in a predetermined position or a pattern which changes its position in accordance with a predetermined pattern may be regarded as the display pattern. Any pattern that can define the position where the display pattern is displayed or that can correct the optical distortion or the like on the light receiving device 120 can be used as the pilot pattern in the embodiment.

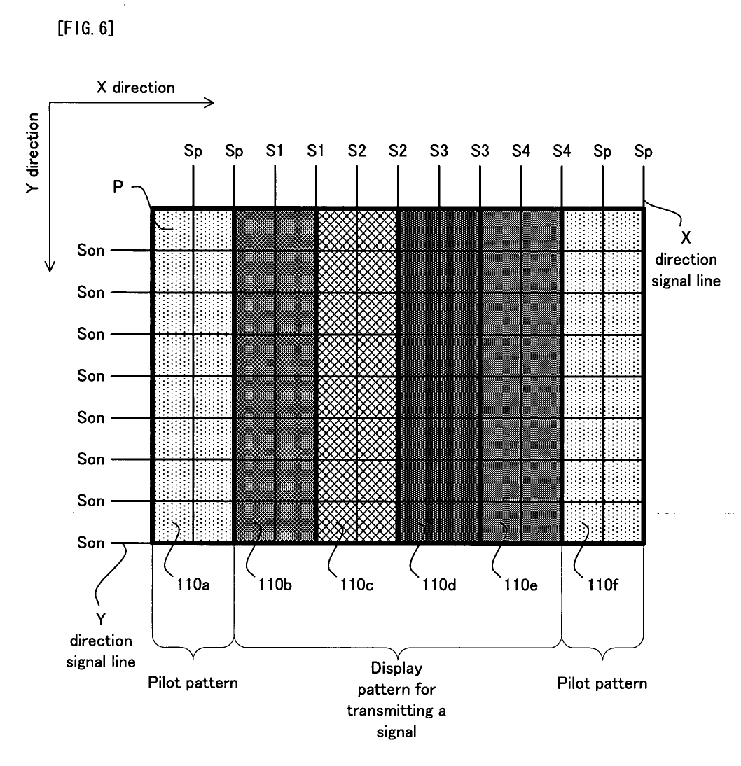

Next, with reference to FIG. 6 to FIG. 8, an explanation will be given on aspects of the division of the display surface and aspects of the pilot pattern. Each of FIG. 6 to FIG. 8 is a plan view conceptually showing an aspect of the division of the display surface and an aspect of the pilot pattern.

FIG. 6 shows enlarged one portion of the display surface of the display device 110. As shown in FIG. 6, the display device 110 is provided with a plurality of X-direction signal lines and a plurality of Y-direction signal lines, and an intersection portion of each direction signal lines constitutes one pixel P. That is, the pixels P on the display device 110 are distributed in a matrix. In FIG. 6, the display surface of the display device 110 is divided into strip-shaped display blocks 110a to 110f, each having long sides in the Y direction. From among the plurality of display blocks 110a to 110f, the display blocks 110a and 110f located on the both sides of the one portion of the display surface are used to display the pilot pattern. The display blocks 110b, 110c, 110d, and 110e located between the display blocks 110a and 110f are used to display the display pattern which indicates the data.

In the display blocks 110b, 110c, 110d, and 110e, the display patterns, which are different from each other, can be displayed. For example, in order to transmit certain one data, the data is divided into four, and then, the display patters, each of which indicates the divided data D1, D2, D3, and D4, are displayed in the corresponding display blocks 110b, 110c, 110d, and 110e. For example, the display pattern which indicates the divided data D1 is displayed in the corresponding display block 110b. The display pattern which indicates the divided data D2 is displayed in the corresponding display block 110c. The display pattern which indicates the divided data D3 is displayed in the corresponding display block 110d. The display pattern which indicates the divided data D4 is displayed in the corresponding display block 110e. That is, in this aspect, it is possible to quadruple the transmission rate, compared to the case that the display surface of the display device 110 is not divided into the plurality of display blocks.

Of course, each of the plurality of display blocks may display respective one of a plurality of display patterns which indicate a plurality of different data, instead of displaying the display pattern which indicates each divided data obtained by dividing one data. For example, the display pattern which indicates data Da is displayed in the corresponding display block 110b. The display pattern which indicates data Db is displayed in the corresponding display block 110c. The display pattern which indicates data Dc is displayed in the corresponding display block 110d. The display pattern which indicates data Dd is displayed in the corresponding display block 110e. Even in this aspect, it is possible to quadruple the transmission rate, compared to the case that the display surface of the display device 110 is not divided into the plurality of display blocks.

Incidentally, in this aspect, as an aspect of inputting a driving signal or a data signal, which is for displaying the display pattern, to the display device 110, it is preferable that ON signals are inputted to the Y-direction signal lines, and pilot pattern display signals Sp or display pattern display signals S1, S2, S3, and S4 are inputted to the X-direction signal lines.

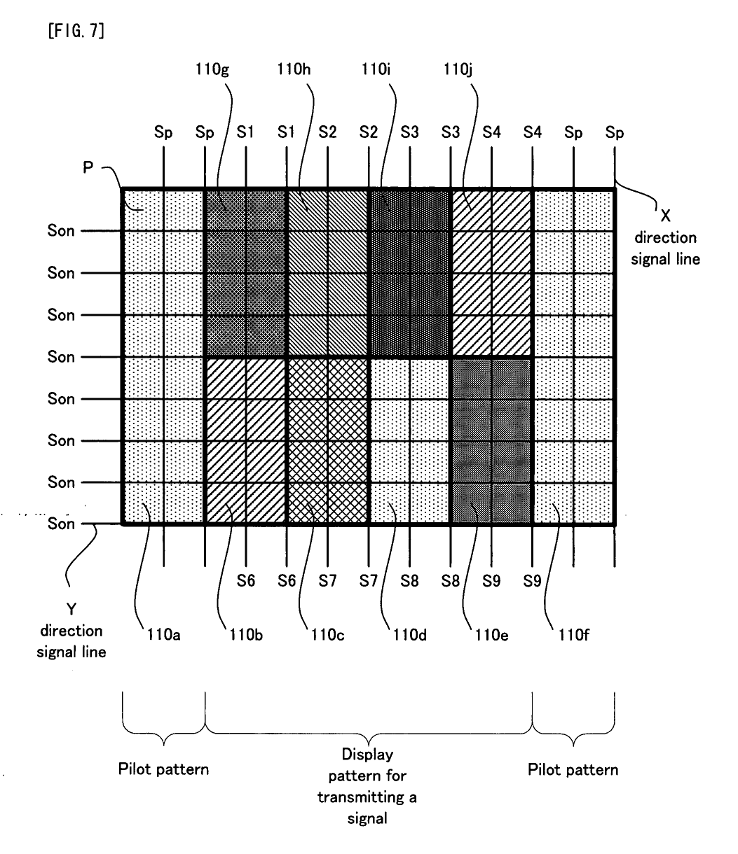

Alternatively, as shown in FIG. 7, in addition to the aspect of the division of the display blocks in FIG. 6, each of the display blocks may be further divided into two in the Y direction. That is, the display surface (or one portion thereof) of the display device 110 may be divided into strip-shaped display blocks 110a to 110j, each having long sides in the Y direction. Then, from among the plurality of display blocks 110a to 110j, the display blocks 110a and 110f are used to display the pilot pattern, and the display blocks 110b, 110c, 110d, 110e, 110f, 110h, 110i, and 110j are used to display the display pattern which indicates the data.

In this case, in the display blocks 110b, 110c, 110d, 110e, 110g, 110h, 110i, and 110j, the display patterns which are different from each other can be displayed. For example, in order to transmit certain one data, the data is divided into eight, and then, the display patters, each of which indicates the divided data D1, D2, D3, D4, D5, D6, D7, and D8 are displayed in the corresponding display blocks 110b, 110c, 110d, 110e, 110g, 110h, 110i, and 110j. For example, the display pattern which indicates the divided data D1 is displayed in the corresponding display block 110b. The display pattern which indicates the divided data D2 is displayed in the corresponding display block 110c. The display pattern which indicates the divided data D3 is displayed in the corresponding display block 110d. The display pattern which indicates the divided data D4 is displayed in the corresponding display block 110e. The display pattern which indicates the divided data D5 is displayed in the corresponding display block 110g. The display pattern which indicates the divided data D6 is displayed in the corresponding display block 110h. The display pattern which indicates the divided data D7 is displayed in the corresponding display block 110i. The display pattern which indicates the divided data D8 is displayed in the corresponding display block 110j. That is, in this aspect, it is possible to octuple the transmission rate, compared to the case that the display surface of the display device 110 is not divided into the plurality of display blocks.

Incidentally, in this aspect, each of the X-direction signal lines is preferably divided into two in the Y direction. More specifically, each of the X-direction signal lines is preferably divided into two in the Y direction, in association with a boundary of the display blocks in the Y direction (e.g. a boundary of the display blocks 110b and 110g, a boundary of the display blocks 110c and 110h, a boundary of the display blocks 110d and 110i, and a boundary of the display blocks 110e and 110j).

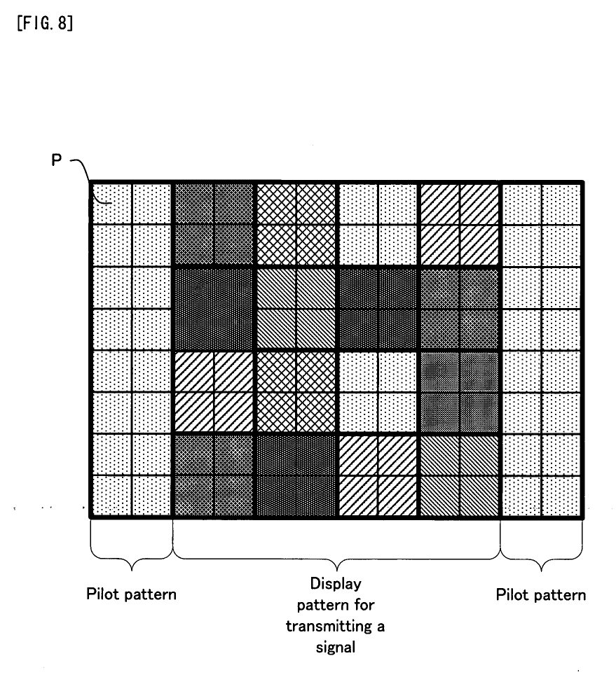

Alternatively, as shown in FIG. 8, the display surface of the display device 110 may be divided such that the display blocks for displaying the display pattern are distributed in a matrix of n×n, for example. In this aspect, it is possible to increase the transmission rate by n×n times, compared to the case that the display surface of the display device 110 is not divided into the plurality of display blocks. Incidentally, in FIG. 8, the X-direction signal lines and the Y-direction signal lines are omitted for simplification of explanation.

The transmission rate will be explained in more details. For example, it is assumed that the display device 110 can perform modulation at a modulation rate of 10 Mbps. In this case, if the display surface (or one portion thereof) of the display device 110 is divided into four, as shown in FIG. 6, the data transmission rate will be 10 Mbps×4=40 Mbps. If the display surface (or one portion thereof) of the display device 110 is divided into eight, as shown in FIG. 7, the data transmission rate will be 10 Mbps×8=80 Mbps. Alternatively, if the display surface (or one portion thereof) of the display device 110 is divided into 100, the data transmission rate will be 10 Mbps×100=1 Gbps. That is, as the number of division of the display surface of the display device 110 is increased, the transmission rate increases.

As explained above, according to the communication system 1 in the embodiment, it is possible to preferably transmit the data from the terminal 1100a to the terminal 100b, or from the terminal 100b to the terminal 100a, by propagating the light corresponding to the display pattern, through a space. In particular, since the display pattern is displayed by the operation of the display device 110, which can perform high-speed modulation, it is possible to increase the amount of data which can be transmitted per unit time. Moreover, it is possible to display the corresponding different display pattern in each of the plurality of divided display blocks. That is, data parallel transmission (or parallel communication) can be performed, so that it is possible to increase the amount of data which can be transmitted per unit time. As described above, according to the communication system 1 in the embodiment, it is possible to preferably transmit a large volume of data through a space. As a result, it is also possible to preferably transmit various contents including video images, audio, or the like.

In addition, for example, general display equipment (e.g. a display or the like) and general imaging equipment (e.g. a camera or the like) can be used as the terminal 100a and the terminal 100b. Thus, in order to realize the communication system 1 in the embodiment, it is not necessary to use relatively expensive or relatively massive exclusive parts. This allows the reduced cost as the entire communication system, to thereby realize the communication system which can be easily handled by a user, relatively easily.

Moreover, the data can be transmitted, as long as each of the pilot pattern and the display pattern is displayed on the transmission-side terminal and the displayed display pattern is light-received on the reception-side terminal. Therefore, it is not necessary to perform a process of selecting the reception-side terminal, which is to light-receive the display pattern, in advance on the transmission-side terminal. The point is that the data can be transmitted as long as the transmission-side terminal displays the pilot data and the reception-side terminal recognizes the pilot pattern. This allows a simple preparation process for the data transmission, to thereby realize the high-response data transmission. A more specific use aspect will be explained. If a user, which takes a picture with a mobile phone with a camera having the aforementioned terminals 100a and 100b, makes the display of the mobile phone, on which the pilot pattern is displayed, face to a television with a camera having the aforementioned terminals 100a and 100b, the data of the taken picture can be immediately transmitted to the television with a camera. The transmitted data can be also immediately displayed on the television with a camera. As described above, it is possible to realize extremely stress-less and high-response data transmission for the user.

Moreover, on the light receiving device 120, since the pilot pattern is used to automatically correct the optical distortion or the like of the display pattern, the handling becomes easy for the user. That is, as long as the user puts the light receiving device 120 of the reception-side terminal closer to the portion in which the display pattern is displayed on the display device 110 of the transmission-side terminal, or as long as the user puts the display device 110 of the transmission-side terminal closer to the light receiving device 120 of the reception-side terminal, the correction is performed on the basis of the pilot pattern, and the preferable data transmission can be realized. In addition, since the transmission rate is high, as described above, it is also possible to complete the data transmission without the hand movement (e.g. shaking or jiggling) of the user, who holds the transmission-side terminal or the reception-side terminal, being problem. In some cases, it is possible to transmit a large volume of data only by holding the transmission-side terminal over the reception-side terminal or by holding the reception-side terminal over the transmission-side terminal.

Incidentally, if the high-speed transmission rate is not requested, the display surface of the display device 110 does not necessarily to be divided into the plurality of display blocks. In this case, a single display pattern may be displayed on the display surface (or one portion thereof) of the display device 110. By this, the division process of dividing the display surface of the display device 110 and the specification process of specifying the PD on the light receiving device 120 are not necessary to be performed, so that it is possible to reduce the processing load of the entire communication system 1.

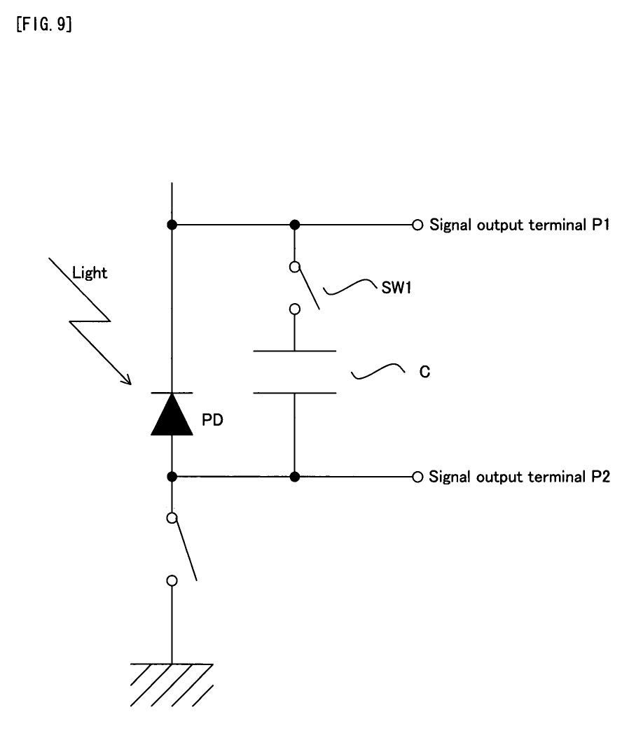

Incidentally, since the display device 110 performs high-speed modulation, the light receiving device 120, which light-receives the display pattern displayed on the display device 110, also needs to have high-speed responsiveness. The structure of the light receiving device 120 will be explained with reference to FIG. 9. FIG. 9 is a circuit diagram conceptually showing the circuit structure of the PD which constitutes the light receiving device 120.

As shown in FIG. 9, two signal output terminals P1 and P2 are provided for one PD on the light receiving device 120 in the embodiment. If a condenser C is not separated from a circuit system by the operation of a switch SW1, electric charge which is generated by the PD receiving the light (i.e. the output signal of the PD) is accumulated on the condenser, and then, outputted to the signal output terminal P1. That is, the signal output terminal P1 is an output terminal which is used if the light receiving device 120 is used as a camera or the like when video images or the like are actually taken.

On the other hand, if the condenser C is separated from the circuit system by the operation of a switch SW2, the electric charge which is generated by the PD receiving the light is directly outputted to the signal output terminal P2. That is, the electric charge is not accumulated on the condenser, and the output signal of the PD is outputted to the signal output terminal P2. Thus, the output signal of the PD can be taken out to the exterior at higher speed. Therefore, by using the signal output terminal P2, it is possible to preferably light-receive the display pattern which is displayed on the display which can perform high-speed modulation.

Moreover, by virtue of such construction that the condenser C can be separated from the circuit system by using the switch SW1, the light receiving device 120 can be used for image shooting or photographing and for the data transmission in the communication system 1 in the embodiment. Therefore, one light receiving device 120 can be used for a plurality of purposes, so that it is possible to improve the availability of the terminals 100a and 100b.

Incidentally, if the PD corresponding to each of the plurality of display blocks is specified, it is only necessary to specify at least one PD in one the display block, and it is only necessary to separate the condenser C of the specified PD from the circuit system.

### (3) Modified Examples

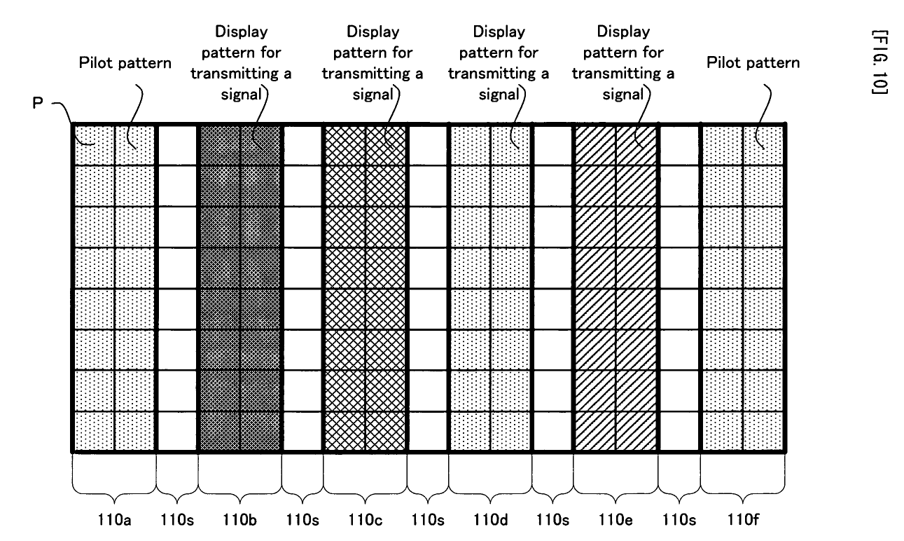

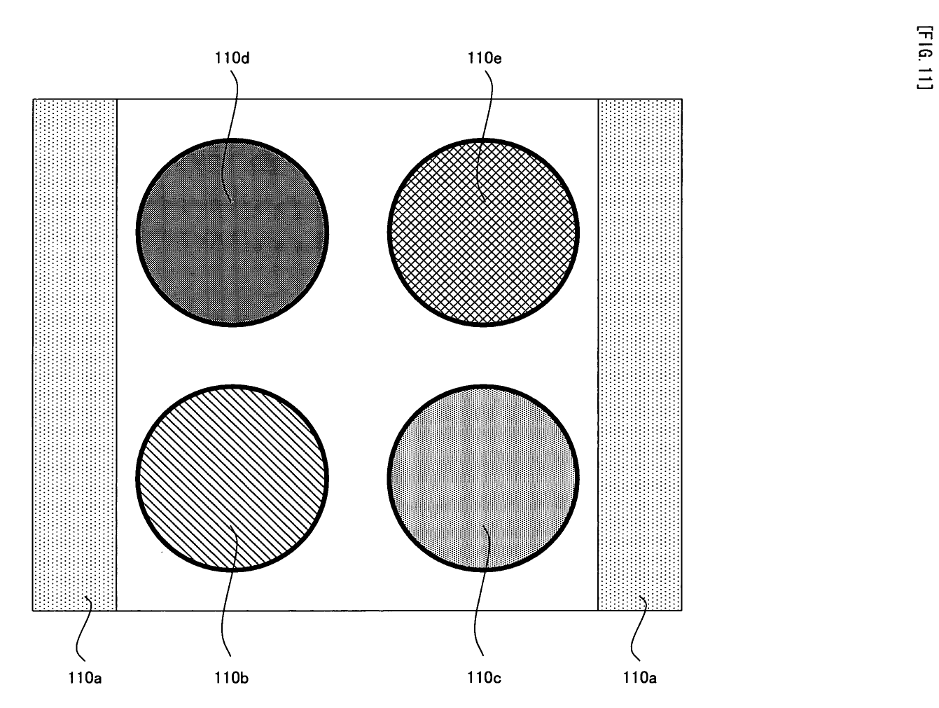

Next, with reference to FIG. 10 and FIG. 11, modified examples of the communication system 1 in the embodiment will be explained. FIG. 10 is a plan view conceptually showing another aspect of the division of the display surface and another aspect of the pilot pattern. FIG. 11 is a plan view conceptually showing another aspect of the division of the display surface and another aspect of the pilot pattern.

As shown in FIG. 10, the display surface of the display device 110 may be divided so as to provide a space block 110s, in which the display pattern and the pilot pattern are not displayed, between each adjacent two of the plurality of display blocks 110a to 110f.

By this, it is possible to preferably prevent such a disadvantage that the pilot pattern or the display pattern displayed in the display block 110a or 110c, which is adjacent to the display block 110b, is light-received by the PD (or PD group) which originally light-receives the display pattern displayed in the display block 110b, for example. Thus, it is possible to reduce or eliminate an influence of crosstalk caused by the display pattern displayed in the adjacent display block.

Incidentally, in addition to or instead of providing the space block, a barrier for blocking leakage light may be provided between each adjacent two of the plurality of display blocks in which the display pattern for transmitting the data is displayed. Even by this, it is possible to reduce or eliminate an influence of crosstalk caused by the display pattern displayed in the adjacent display block.

As shown in FIG. 11, the plurality of display blocks 110b to 110e, in which the display pattern which indicates the data to be transmitted is displayed, may have a circular shape. By virtue of such construction, it is possible to reduce or eliminate an influence of crosstalk caused by defocus.

In the present invention, various changes may be made without departing from the essence or spirit of the invention which can be read from the claims and the entire specification. A communication system, a communicating apparatus and method, and a computer program, which involve such changes, are also intended to be within the technical scope of the present invention.

### INDUSTRIAL APPLICABILITY

The communication system, the communicating apparatus and method, and the computer program according to the present invention can be applied to a communication system for consumer use or for business use, in which a predetermined signal can be transmitted through a space.

1-15. (canceled)

16. A communication system comprising: a first communication apparatus; and a second communicating apparatus,
said first communicating apparatus comprising:
(i) a displaying device which can perform high-speed modulation;
(ii) a display dividing device for dividing a display surface of said displaying device into a plurality of display blocks; and
(iii) a controlling device for controlling said displaying device to display a display pattern, which indicates corresponding predetermined data, in each of the divided plurality of display blocks,
said second communicating apparatus comprising:
(i) a light receiving device for light-receiving the display pattern which is displayed on said displaying device; and
(ii) an obtaining device for obtaining the predetermined data on the basis of the light-received display pattern,
the display pattern including a pilot pattern which indicates a reference position of the display pattern, and
said second communicating apparatus further comprising:
(iii) a correcting device for correcting at least one of a distortion of the light-received display pattern, an angle of the light-received display pattern, a position of the light-received display pattern, and a focus of said light receiving device when the display pattern is light-received, on the basis of the pilot pattern; and
(iv) a light receiving dividing device for dividing a light receiving surface of said light receiving device into a plurality of light receiving blocks corresponding to the respective plurality of display blocks, on the basis of a correction result of said correcting device.

17. The communication system according to claim 16, wherein said displaying device includes an organic EL (Electro Luminescence) display.

18. The communication system according to claim 16, wherein said dividing device divides the display surface into a plurality of strip blocks which extend in one direction, as the plurality of display blocks.

19. The communication system according to claim 16, wherein said dividing device divides the display surface into a plurality of strip blocks which extend in one direction and which are further divided into another direction which is different from the one direction, as the plurality of display blocks.

20. The communication system according to claim 16, wherein said dividing device divides the display surface into the plurality of display blocks which are distributed in a matrix.

21. The communication system according to claim 16, wherein said controlling device controls said displaying device to display the pilot pattern before the display of the display pattern.

22. The communication system according to claim 16, wherein said light receiving device comprises a photo detector element including a condenser which can be separated from a circuit system.

23. A communicating apparatus comprising:
a displaying device which can perform high-speed modulation;
a display dividing device for dividing a display surface of said displaying device into a plurality of display blocks;
a controlling device for controlling said displaying device to display a display pattern, which indicates corresponding predetermined data, in each of the divided plurality of display blocks;
a light receiving device for light-receiving the display pattern which is displayed on said displaying device; and
an obtaining device for obtaining the predetermined data on the basis of the light-received display pattern,
the display pattern including a pilot pattern which indicates a reference position of the display pattern, and
said communicating apparatus further comprising:
a correcting device for correcting at least one of a distortion of the light-received display pattern, an angle of the light-received display pattern, a position of the light-received display pattern, and a focus of said light receiving device when the display pattern is light-received, on the basis of the pilot pattern; and
a light receiving dividing device for dividing a light receiving surface of said light receiving device into a plurality of light receiving blocks corresponding to the respective plurality of display blocks, on the basis of a correction result of said correcting device.

24. A communicating method in a communication system comprising: a first communication apparatus; and a second communicating apparatus, said first communicating apparatus comprising a displaying device which can perform high-speed modulation, said second communicating apparatus comprising a light receiving device for light-receiving the display pattern which is displayed on said displaying device,
said communicating method comprising:
a display dividing process of dividing a display surface of said displaying device into a plurality of display blocks;
a controlling process of controlling said displaying device to display a display pattern, which indicates corresponding predetermined data, in each of the divided plurality of display blocks; and
an obtaining process of obtaining the predetermined data on the basis of the light-received display pattern,
the display pattern including a pilot pattern which indicates a reference position of the display pattern, and
said communicating method further comprising:
a correcting process of correcting at least one of a distortion of the light-received display pattern, an angle of the light-received display pattern, a position of the light-received display pattern, and a focus of said light receiving device when the display pattern is light-received, on the basis of the pilot pattern; and
a light receiving dividing process of dividing a light receiving surface of said light receiving device into a plurality of light receiving blocks corresponding to the respective plurality of display blocks, on the basis of a correction result of said correcting process.

25. A computer program product in a computer-readable medium for tangibly embodying a program of instructions executable by a computer provided in a communication system comprising: a first communication apparatus; and a second communicating apparatus, said first communicating apparatus comprising: (i) a displaying device which can perform high-speed modulation; (ii) a display dividing device for dividing a display surface of said displaying device into a plurality of display blocks; and (iii) a controlling device for controlling said displaying device to display a display pattern, which indicates corresponding predetermined data, in each of the divided plurality of display blocks, said second communicating apparatus comprising: (i) a light receiving device for light-receiving the display pattern which is displayed on said displaying device; and (ii) an obtaining device for obtaining the predetermined data on the basis of the light-received display pattern, the display pattern including a pilot pattern which indicates a reference position of the display pattern, and said second communicating apparatus further comprising: (iii) a correcting device for correcting at least one of a distortion of the light-received display pattern, an angle of the light-received display pattern, a position of the light-received display pattern, and a focus of said light receiving device when the display pattern is light-received, on the basis of the pilot pattern; and (iv) a light receiving dividing device for dividing a light receiving surface of said light receiving device into a plurality of light receiving blocks corresponding to the respective plurality of display blocks, on the basis of a correction result of said correcting device,
said computer program making a computer function as at least one portion of said first communicating apparatus and said second communicating apparatus.
